(19) United States
(12) Patent Application Publication
(10) Pub. No.: US 2007/0074913 A1
(43) Pub. Date: Apr. 5, 2007

(54) Capacitive touch sensor with independently adjustable sense channels

(76) Inventors: Bernard O. Geaghan, Salem, NH (US); Craig A. Cordeiro, Westford, MA (US)

Correspondence Address: 3M INNOVATIVE PROPERTIES COMPANY, PO BOX 33427, ST. PAUL, MN, 55133-3427, US

(21) Appl. No.: 11/243,533

(22) Filed: Oct. 5, 2005

(51) Int. Cl. G08C 21/00

(52) U.S. Cl. 178/18.06

(57) ABSTRACT

Touch sensing systems and methods employ a touch surface and a touch sensor. An array of electrodes of the touch sensor is configured to capacitively couple to a touch in proximity with the touch surface. Circuitry is coupled to each electrode via a channel and configured to sense signals present on the electrodes. The circuitry is configured to independently adjust a sensed response of each electrode. For example, the circuitry may be configured to adjust a gain of each channel, an offset of each channel, or a gain and offset of each channel.

### FIELD OF THE INVENTION

The present invention relates to methods and systems for sensing a touch in proximity with a touch surface.

### BACKGROUND

Interactive electronic displays are widely used. In the past, use of interactive electronic displays has been primarily limited to computing applications, such as desktop computers and notebook computers. As processing power has become more readily available, electronic displays are being integrated into a wide variety of applications. For example, it is now common to see interactive electronic displays in applications such as teller machines, gaming machines, automotive navigation systems, restaurant management systems, grocery store checkout lines, gas pumps, information kiosks, and hand-held data organizers, to name a few.

Interactive displays often include some form of touch sensitive screen. Integrating touch sensitive panels with visual displays is becoming more common with the emergence of portable multimedia devices. Capacitive touch sensing techniques for touch sensitive panels involve sensing a change in a signal due to capacitive coupling created by a touch on the touch panel. An electric field is applied to electrodes on the touch panel. A touch on the touch panel couples in a capacitance that alters the electric field in the vicinity of the touch. The change in the field is detected and used to determine the touch location. Increasing the accuracy and/or decreasing the processing time of touch location determination is desirable.

### SUMMARY OF THE INVENTION

The present invention is directed to touch sensing systems and methods. Embodiments of the present invention provide for compensating for coupling characteristics of individual electrodes of an array in a capacitive touch sensor, or of an array of electrodes, collectively, and/or user actuatable switches.

According to embodiments of the present invention, a touch sensing system includes at least one touch surface and at least one touch sensor. A touch sensor includes an array of electrodes configured to capacitively couple to a touch in proximity with the touch surface. Circuitry is coupled to each electrode via a channel and configured to sense signals present on the electrodes. The circuitry is configured to independently adjust a sensed response of each electrode.

For example, the circuitry may include a processor configured to implement an algorithm to adjust the sensed response of each electrode. The circuitry may be configured to adjust the sensed response of each channel such that a parameter of sensed signals is substantially the same among individual channels. The circuitry may be configured to adjust the sensed response of each channel by adjusting a gain of each channel, an offset of each channel, or a gain and offset of each channel. For example, the circuitry may be configured to adjust an offset to substantially null a parasitic capacitance associated with each channel.

According to various embodiments, each channel may include, or is switchably coupled to, an integrator. The integrator may be coupled to a digital-to-analog converter (DAC). The DAC may be configured as a pulse width modulator. The circuitry may be configured to integrate signals present on the electrodes. For example, each channel may include an integrator having an integration time constant, and the circuitry may be configured to adjust a gain of each channel by adjusting the integration time constant of the integrator. By way of further example, the circuitry may be configured to adjust a gain of each channel by adjusting an integration time of the integrator. The circuitry may be configured to perform signal processing with the integrator and adjust an offset of the integrator.

Each channel may include, or is switchably coupled to, an analog-to-digital converter (ADC). The circuitry may be configured to adjust the sensed response of each channel to fall within a range of the ADC. For example, the circuitry may be configured to adjust the sensed response of each channel to correspond to a maximum range of the ADC in the absence of the touch in proximity with the touch surface.

The circuitry may be coupled to one or more user actuatable switches through individual input/output channels. The circuitry may be configured to independently adjust one or both of a gain and an offset of each input/output channel. For example, the circuitry may include an ADC coupled to each of the channels and input/output channels. The circuitry may be configured to adjust one or both of the gain and offset of each input/output channel and one or both of a gain and an offset of each channel such that sensed signals communicated by the respective channels are within range of the ADC.

In accordance with other embodiments, methods of the present invention may be implemented for use with a touch sensor having a touch surface. Such methods may involve measuring signals present on electrodes of an array of electrodes. The electrodes may be configured to capacitively couple to a touch in proximity with the touch surface. Methods may further involve independently adjusting a sensed response of each electrode.

Adjusting the sensed response of each electrode may involve algorithmically adjusting the sensed response of each electrode. Adjusting the sensed response of each electrode may involve adjusting a sensed response of a channel coupled to each electrode such that a parameter of sensed signals is substantially the same among individual channels. Adjusting the sensed response of each electrode may involve adjusting a gain, offset, or gain and offset of individual channels coupled to respective electrodes. For example, adjusting the sensed response of each electrode may involve substantially nulling a parasitic capacitance associated with individual channels coupled to respective electrodes.

Measuring the signals may involve integrating the signals, and adjusting the sensed response of each electrode may involve adjusting a time constant of integration or an integration time to adjust a gain of individual channels coupled to respective electrodes. Adjusting the sensed response of each electrode may involve performing signal processing with signal integration to adjust an offset of individual channels coupled to respective electrodes. Measuring the signals may further involve measuring signals received from input/output channels coupled to user actuatable switches, and independently adjusting one or both of a gain and an offset of each input/output channel.

The above summary of the present invention is not intended to describe each embodiment or every implementation of the present invention. Advantages and attainments, together with a more complete understanding of the invention, will become apparent and appreciated by referring to the following detailed description and claims taken in conjunction with the accompanying drawings.

### BRIEF DESCRIPTION OF THE DRAWINGS

FIG. 1 is a general model of a circuit that may be used to measure touch signals on an array capacitive touch sensor in accordance with embodiments of the present invention;

FIG. 2 illustrates touch response signals developed by individual electrodes of an array capacitive touch sensor, with differences in signal magnitudes resulting from differing signal coupling characteristics of individual electrodes;

FIG. 3 is a flow diagram of a method for compensating for variations in electrode coupling characteristics in accordance with embodiments of the present invention;

FIG. 4 is a flow diagram of a method for compensating for variations in electrode coupling characteristics and other input/output channel characteristics in accordance with embodiments of the present invention;

FIG. 5 illustrates the effects of varying parasitic capacitance and impedances when detecting uncalibrated touch response signals using an integrator and analog-to-digital converter (ADC;

FIG. 6 illustrates the effects of compensating for varying parasitic capacitance and impedances when detecting calibrated touch response signals using an integrator and ADC in accordance with the principles of the present invention;

FIG. 7 illustrates eight sense channel output signals for eight electrodes of an array capacitive touch sensor, the eight sense channel output signals representative of non-compensated signals whose characteristics may differ as a result of varying parasitic capacitance and impedances of the eight sense channels;

FIG. 8 illustrates the eight sense channel output signals shown in FIG. 7 that have been calibrated in accordance with the principles of the present invention;

FIG. 9 is a block diagram of a system for calibrating sense channel output signals in accordance with embodiments of the present invention;

FIG. 10 is a block diagram of circuitry configured for calibrating one or more parameters of a sensed response of each of a number of touch sensor electrodes in accordance with embodiments of the present invention; and

FIG. 11 illustrates a touch sensing system that incorporates a touch sensor which provides for gain and/or offset calibration on a per-sense channel basis in accordance with the principles of the present invention.

While the invention is amenable to various modifications and alternative forms, specifics thereof have been shown by way of example in the drawings and will be described in detail. It is to be understood, however, that the intention is not to limit the invention to the particular embodiments described. On the contrary, the intention is to cover all modifications, equivalents, and alternatives falling within the scope of the invention as defined by the appended claims.

### DETAILED DESCRIPTION OF VARIOUS EMBODIMENTS

In the following description of the illustrated embodiments, reference is made to the accompanying drawings that form a part hereof, and in which is shown by way of illustration, various embodiments in which the invention may be practiced. It is to be understood that the embodiments may be utilized and structural changes may be made without departing from the scope of the present invention.

Various embodiments described below are based on an array (e.g., matrix) capacitive touch technology, although the concepts are equally applicable to other types of capacitive touch sensors that employ one or more layers of electrodes, such as one or more arrays of electrodes, including, for example, the single-layer sensors described in commonly-owned U.S. Pat. No. 6,825,833, which is hereby incorporated herein by reference.

Touch screens in accordance with embodiments of the present invention may be opaque or transparent, depending on their intended application. For transparent touch screens, the electrodes may be formed of a transparent conductive material, such as indium tin oxide (ITO) or other transparent conductor deposited on a transparent substrate, such as glass or polyethylene terapthalate (PET). For applications that do not require transparency, electrodes may be made of metal or other conductive materials. Transparent touch screens are often used in conjunction with a display that is viewable through the touch screen.

In various implementations, capacitive touch sensors may include a layer of substantially parallel electrodes, or may include first and second layers of substantially parallel electrodes, or may include a first layer of electrodes with a planar electrode or shield disposed on a second layer, or may include other electrode configurations. Touch sensing involves detecting changes in electrical signals present at the electrodes in the vicinity of a touch. In some implementations, the touch sensor may use a first layer of parallel electrodes to sense the touch location in the Y-direction and a second layer of parallel electrodes, arranged orthogonally to the first layer electrodes, to detect the touch location in the X-direction. The X and Y electrodes are driven with applied electrical signals. A touch to the touch surface capacitively couples X and Y electrodes in the vicinity of the touch to ground, or to nearby electrodes. The capacitive coupling causes a change in the electrical signal on the electrodes near the touch location. The amount of capacitive coupling to each electrode, and thus the change in the signal on the electrode, varies with the distance between the electrode and the touch. The X and Y touch location may be determined by examining the changes in the electrical signals detectable on the X and Y electrode arrays.

Array capacitive touch sensor types and installations can vary greatly, and, for a given sensor type, the electrodes in an array do not all have the same signal coupling characteristics. Individual electrodes, often referred to as electrode bars, can vary significantly in terms of parasitic capacitances and resistive impedance. Factors that can influence the degree of variability of individual electrode coupling characteristics include variation in the width or thickness or resistivity of electrodes. Another factor is the difference in the thickness and dielectric constant of the overlay between the touch surface and the electrodes.

Parasitic capacitance coupling to each electrode in an array (and to the interconnections to each electrode) and differences in distance, parasitic capacitance, and shielding effect between upper and lower layers of electrodes contribute to variability of coupling characteristics of individual electrodes. Edge conditions, such as differences between edge electrodes and other electrodes in an array (e.g., parasitic capacitance to driven shields, grounded shields, bezel, chassis, etc.) also contribute to variability of coupling characteristics of individual electrodes. Switches, connectors, devices, and other components within the touch signal conduction path or channel vary in terms of parasitic capacitance or feed through capacitance and impedance, thereby contributing to the variability of coupling characteristics of individual electrodes.

Further, it is typically desirable to alter the gain response of upper and lower electrode arrays of a two-layer array capacitive touch sensor, such as by having an increased gain response on the more distant electrode plane (i.e., the electrode array furthest from the touch surface). These and other integration factors can cause significant variations in sensed signal response characteristics (e.g., amplitude and/or response) as between individual electrodes of a capacitive electrode array.

Methods and systems of the present invention are directed to embodiments that compensate for coupling characteristics of individual electrodes of an array capacitive touch sensor, or of an array of electrodes, collectively. For example, the gain response of each array or each electrode of the array may be adjusted to be substantially the same. By way of further example, each electrode sense channel has unique parasitic or stray capacitance and resistive impedance characteristics relative to other electrode sense channels. An offset may be adjusted for each electrode sense channel to effectively null the parasitic capacitance and impedances unique to each channel, thereby enhancing the touch sensor's ability to detect relatively small changes in coupling capacitance resulting from a touch proximate the electrodes.

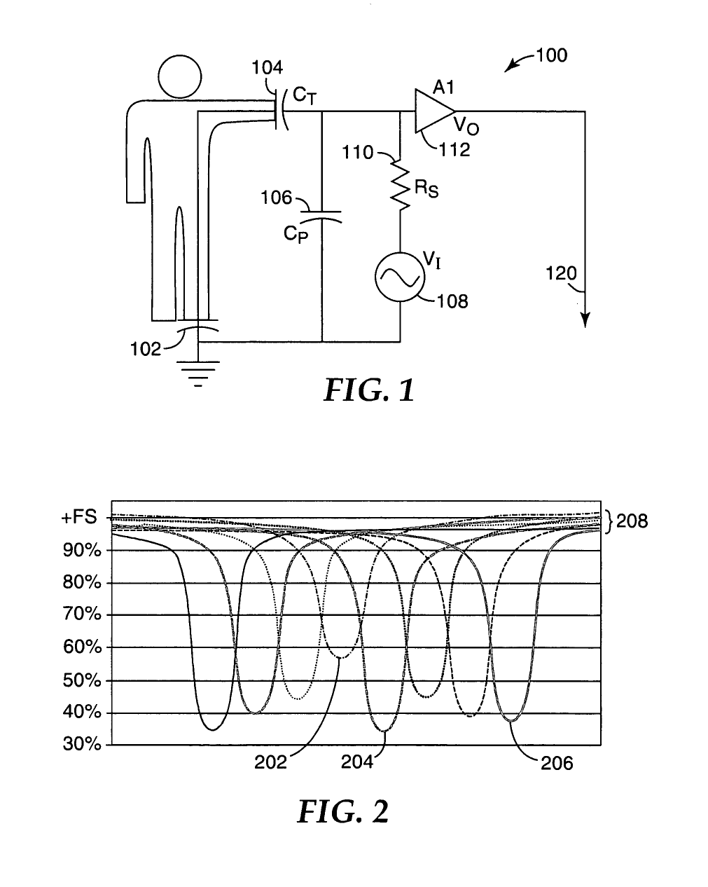

Turning now to FIG. 1, there is shown a general model of a circuit 100 that may be used to measure touch signals on an array capacitive touch sensor. This model facilitates an understanding of the role parasitic capacitance plays in array or matrix capacitive touch sensors and touch detection sensitivity. In FIG. 1, a touch in proximity to a touch surface of the array touch sensor is detected as a touch capacitance (C_{T}) 104 (in series with the user's body capacitance 102), which is shown in a parallel relationship with the parasitic capacitance (C_{P}) 106. A drive signal is applied to the electrode by drive voltage source (V_{I}) 108 coupled to amplifier 112 via source resistance (Rₛ) 110.

From the model shown in FIG. 1, the change in measured voltage V_{O} relative to change in touch capacitance C_{T} (i.e., dV_{O}/dC_{T}) may be calculated for a given set of conditions as follows:
V_{O}=V_{I}*(1/jwC)/[R+(1/jwC)] Equation [1]
V_{O}=V_{I}*1/(1+RjwC_{P}+RjwC_{T}) Equation [2]
V_{O}=V_{I}*(1+RjwC_{P}+RjwC_{T})⁻¹ Equation [3]
dV_{O}/dC_{T}=−V_{I}*[−jwR/(1+RjWC_{P}+RjWC_{T})²] Equation [4]
dV_{O}/dC_{T}=−V_{I}*jw*R/(1+Rjw(C_{P}+C_{T}))² Equation [5]
where C_{T} is the touch capacitance, C_{P} is the parasitic capacitance of an electrode, V_{I} is the drive voltage source with frequency jw, V_{O} is the measured voltage, R is the source resistance of the measurement circuit, and V_{I} and R_{S} are constants.

Equation 5 is a measure of the sensitivity of a system to a capacitively coupled signal (touch or stylus). This sensitivity changes with variations in parasitic capacitance among electrodes of an array or matrix, and with variations among electronic components, giving some electrodes a different sensitivity than others to the same touch or stylus signal.

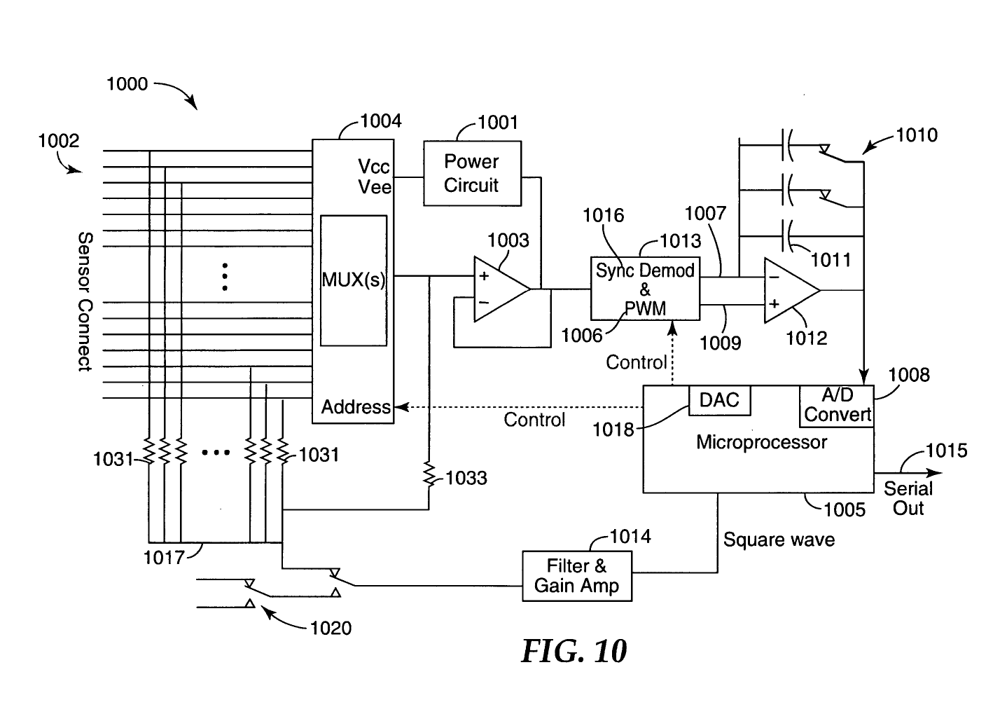

FIG. 2 illustrates eight touch response signals associated with eight electrodes of an array capacitive touch sensor having a touch detector that operates generally in accordance with the model shown in FIG. 1. It is understood that other components (e.g., multiplexer coupled to N array electrodes), such as those shown in the FIG. 10, are typically needed to generate the uncompensated touch response signals depicted in FIG. 2, but are omitted for purposes of simplicity of explanation. Each touch response signal shown in FIG. 2 represents the measured voltage, V_{O}, provided at the output 120 of amplifier 112 for individual electrodes of the array. As is evident from the waveforms illustrated in FIG. 2, the touch response signals for the eight electrodes vary significantly in terms of signal strength or magnitude (note the different amplitudes of signals 202, 204, and 206 that represent the voltage VO on three of eight electrodes in the presence of a touch, and the signal range 208 that represents the range of signal magnitudes with no proximate touch). These differences in signal strength result from variations in parasitic capacitance and impedance unique to the sense channels associated with each electrode of the array. If these differences are left uncompensated, detection of touch response signals may be adversely affected.

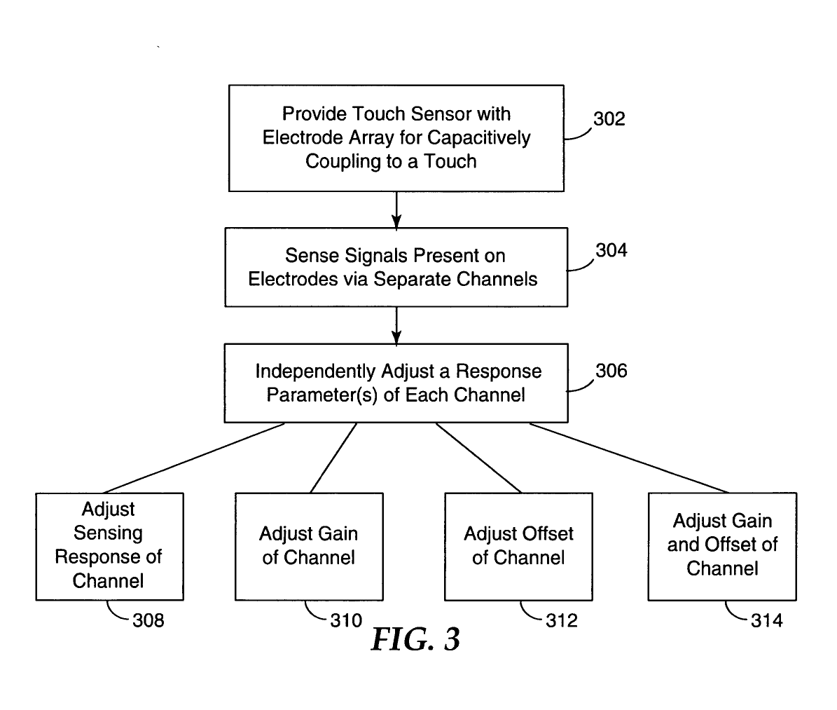

Referring now to FIG. 3, there is illustrated a flow diagram of a method for compensating for variations in electrode coupling characteristics in accordance with embodiments of the present invention. As is shown in FIG. 3, a touch sensor that includes an electrode array configured to capacitively couple to a touch in proximity with a touch surface of the sensor is provided 302. Each electrode is associated with an individual sense channel. Signals present on the electrodes are sensed 304 on the individual channels. A response parameter of each channel is independently adjusted 306 as needed or desired. For example, a sensing response of each channel may be adjusted 308 on an individual basis, or on a per array basis. A gain of each channel may be adjusted 310 on an individual basis or on a per array basis. An offset of each channel may be adjusted 312 on an individual or an array basis. Multiple parameters may be adjusted 314 on a per-channel basis or a per array basis, such as the gain and offset of each sense channel.

In accordance with other embodiments, a touch sensor's controller may be configured to include input/output (I/O) channels that couple to user-actuatable capacitive switches or other components, in addition to the electrode sense channels. For example, a touch panel system for automotive applications may include a number of user-actuatable navigation switches or other buttons that allow the user to select/control the display characteristics and/or content presented on the touch panel system. Typically, such additional I/O channels have parasitic capacitance and impedance characteristics that vary significantly from those associated with electrode sense channels of the touch sensor. Notwithstanding these differences, a compensation methodology of the present invention provides for independent adjustment of additional I/O channel characteristics in a manner that allows for detection of signals communicated by such I/O channels and electrode sense channels using common detection circuitry (e.g., electrode and I/O signals are calibrated to fall within the range of the measuring circuitry, such as that of an integrator and/or an analog-to-digital converter).

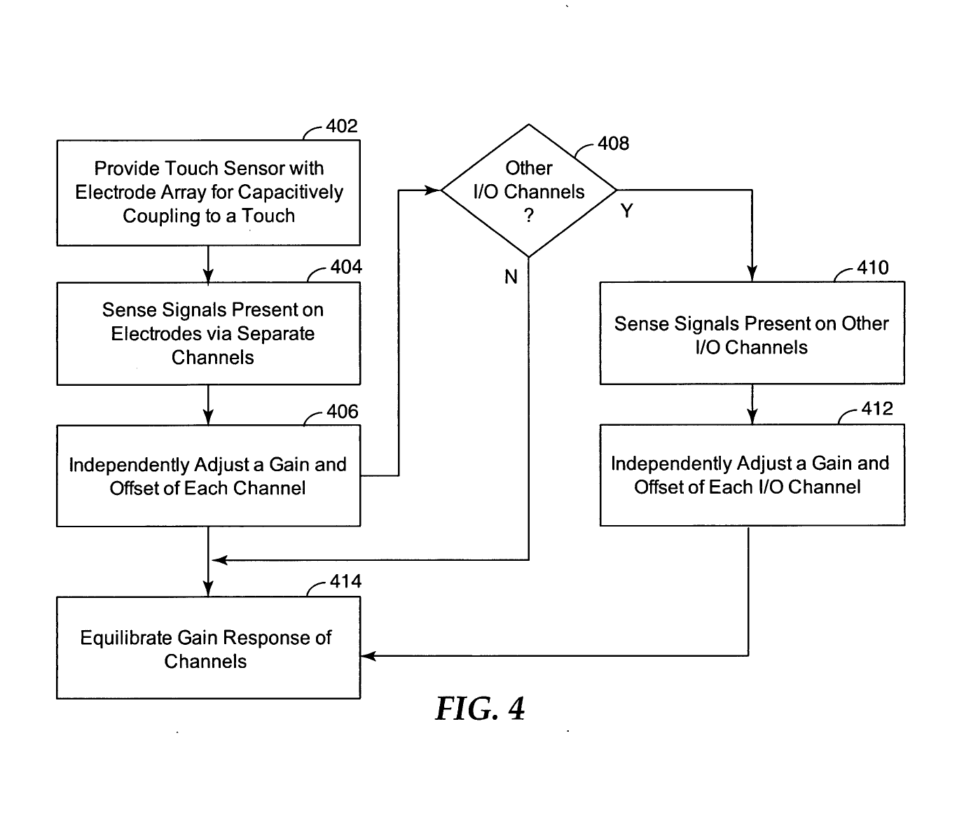

According to such embodiments, and with reference to FIG. 4, a touch sensor that includes an electrode array configured to capacitively couple to a touch in proximity with a touch surface of the sensor is provided 402, and signals present on the electrodes are sensed 404 on the individual channels. Gain and offset are independently adjusted 406 for each sense channel. If other I/O channels are present 408, sense signals present on these I/O channels are sensed 410. Gain and offset are independently adjusted 412 for each I/O channel. For example, the gain of each electrode sense channel and each I/O channel may be equilibrated to substantially the same value or to fall within range of the measuring componentry (e.g., integrator, ADC).

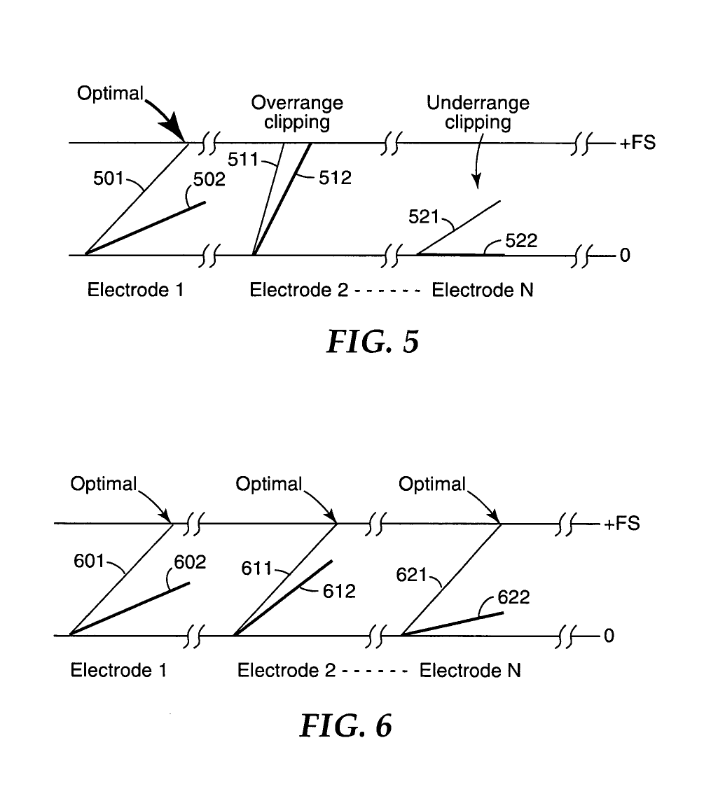

FIGS. 5 and 6 illustrate the effects of varying parasitic capacitance and impedances when detecting touch response signals using an integrator and ADC. The ramp-like signals 501, 502, etc. represent the output of an integrator that is accumulating the V_{O} signal over a period of time. The output of the integrator is fed into an ADC, that has a count range defined by a minimum count (e.g., zero count) and a maximum count (e.g., max or full scale count). A typical ADC has a count range within which the magnitude of an analog signal can be determined. For example, FIGS. 5 and 6 illustrate an ADC count range defined by a no-touch condition (maximum ADC count) and a touch condition (zero ADC count). FIG. 5 illustrates non-compensated sense channel signal outputs for electrodes 1, 2, and N. FIG. 6 illustrates the same sense channel signal outputs for electrodes 1, 2, and N after compensating for channel parasitic capacitance and impedance variability in accordance with the present invention.

As is shown in FIG. 5, sense channel integrator output signal 501 for a no-touch condition represents optimal measurement calibration of the sense channel for electrode 1, in that the full dynamic range of the integrator and ADC is made available for detecting a touch. The no-touch condition is accumulated in an integrator, resulting in a signal ramp of duration T that stops at +full scale (+FS) of the ADC, and is thus registered as a maximum count of the ADC. Sense channel output signal 502 represents a touch condition, the magnitude of which ramps to a value that is comfortably within the range of the ADC. The magnitude of the touch is accurately reflected by the ADC count for sense channel output signal 502 relative to sense channel output signal 501.

Sense channel output signal 511 represents a sub-optimal no-touch condition of the sense channel for electrode 2. Signal 511 is integrated over time T, and the signal 511 magnitude is too large, so the integrator reaches and exceeds +FS before integration time T ends. Thus, the value of the no-touch signal is inaccurately detected as a +FS value. As can be seen from sense channel output signal 512, a signal is integrated over time T, and again the integrator reaches and exceeds +FS before integration time T ends. The value of the touch signal is also inaccurately detected as a +FS value, and no difference is detected between the touched and non-touched conditions. Sense channel output signal 521 represents a sub-optimal under-range no-touch condition of the sense channel for electrode N, whereby a small signal is accumulated on an integrator during time T. In a touched condition represented by signal 522, touch detection resolution is lost as the touch magnitude appears to bottom out to or near a zero ADC count.

FIG. 6 illustrates the same sense channel output signals shown in FIG. 5 that have been calibrated in accordance with the principles of the present invention. No compensation to sense channel output signal 601 is made in view of this channel's optimal no-touch measurement calibration status. As in FIG. 5, the magnitude of sense channel output signal 602 integrates over time duration T to a level comfortably within the range of the ADC, and the magnitude of the touch is accurately reflected by the ADC count for sense channel output signal 602 relative to sense channel no-touch signal 601. The overrange clipping condition of electrode 2 is corrected, such that the no-touch condition 611 properly registers at the maximum ADC count. The magnitude of a low-magnitude touch is now accurately reflected by the ADC count for sense channel output signal 612. The underrange condition of electrode 3 is corrected, such that the no-touch condition 621 properly registers at the maximum ADC count. The magnitude of a high-magnitude touch is now integrated to a point above zero and is accurately reflected by the ADC count for sense channel output signal 622.

It can be appreciated that if the affects of parasitic capacitance and impedance variability across the electrodes of an electrode array are not compensated, detection of touch response signals is adversely affected. In an implementation that uses an ADC in the touch detector, the gain of the detector would have to be reduced to a lowest common value in order to get all sense channel output signals within range of the ADC, thereby reducing the dynamic range of the detector. Among other advantages, methodologies of the present invention allow for the use of less expensive, lower resolution ADCs, and provide for increases in the useable dynamic range of the touch signal. Implementations of the present invention eliminate the need for (but does not exclude) a per-electrode variable drive amplitude, which reduces drive circuit cost and complexity.

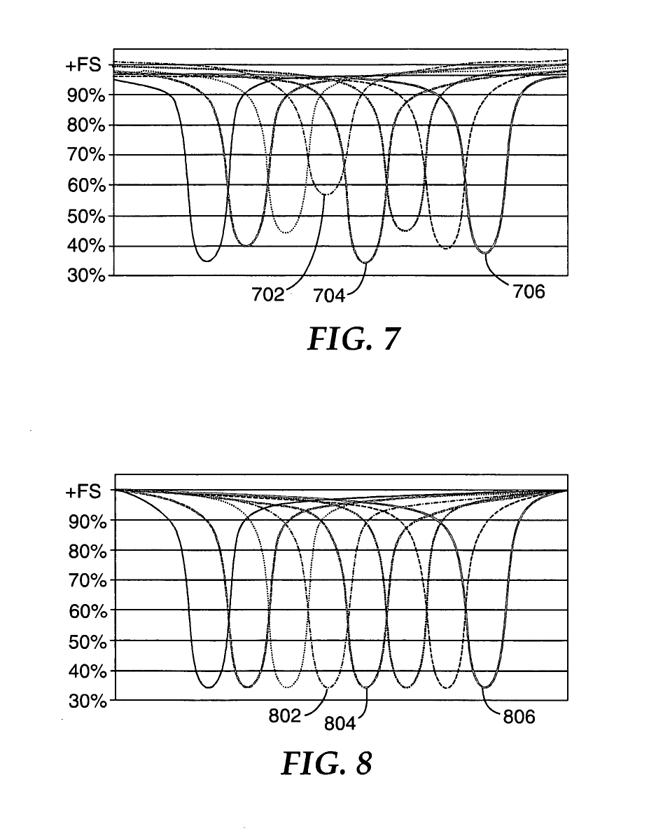

FIG. 7 illustrates eight sense channel output signal magnitudes for eight electrodes of an array capacitive touch sensor vs. distance in the plane of the sensor. The eight sense channel output signals shown in FIG. 7 represent non-compensated signals whose characteristics differ as a result of varying parasitic capacitance and impedances of the eight sense channels. The depiction of FIG. 7 shows differences between the amplitudes of the eight sense channel output signals (e.g., noting signals 702, 704, and 706).

FIG. 8 illustrates the eight sense channel output signals shown in FIG. 7 that have been calibrated in accordance with the present invention. Each of the eight sense channel output signals have been individually adjusted so that the amplitudes of the eight signals are substantially the same. In this example, the amplitudes of the eight sense channel output signals have been set substantially equal to the maximum count of the ADC, which is representative of a no-touch condition of the touch sensor (e.g., noting the adjustment of the amplitudes of signals 702, 704, and 706 to that of signals 802, 804, and 806). It is understood that characteristics other than the amplitudes of the sense channel output signals may be subject to variation as between channels, and that a compensation methodology of the present invention may be use to correct for such other variations.

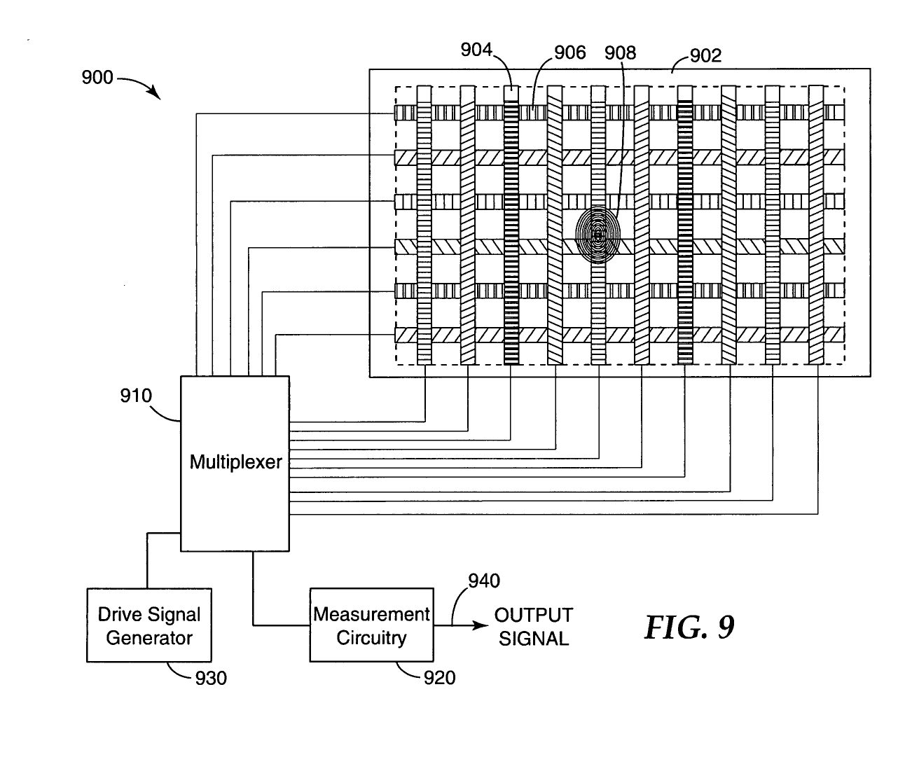

FIG. 9 is a block diagram of a system 900 for calibrating sense channel output signals in accordance with embodiments of the present invention. The system 900 shown in FIG. 9 includes an array (e.g., matrix) capacitive touch sensor 902 that includes two layers of electrodes. A top layer of electrodes 904 arranged orthogonally to a bottom layer of electrodes 906 as illustrated in plan view in FIG. 1. Each of the top and bottom electrode layers 904, 906 includes an array of several spaced-apart electrodes. A representative touch 908 to the touch surface of the sensor 902 is shown for illustrative purposes.

Each electrode of the top and bottom electrode layers 904, 906 is connected to a multiplexer 910 through a signal line. A drive signal generator 930 is coupled to the multiplexer 910 and is configured to generate an AC drive signal for application to the electrodes of the touch sensor 902. The multiplexer 910 typically applies the drive signal to all electrodes simultaneously, but may apply a drive signal to selected electrode(s). The multiplexer 910 is configured to selectively couple the signal lines of the electrodes to measurement circuitry 920. In particular, the multiplexer 910 is configured to select individual signal lines so that each sense channel may be subject to measurement calibration on an individual basis. The measurement circuitry 920 is configured to compensate for effects of varying parasitic capacitance and impedances of individual sense channels, such as by equilibrating a gain response of the sense channels of touch sensor 902 or adjusting the gain response so all electrode sensed signals are within range of the ADC. The signal 940 output from the measurement circuitry 920 is typically a digital representation of a touch response signal operated on by the measurement circuitry 920.

It is understood that multiplexer 910 need not be used, but that inclusion of same reduces complexity of the circuitry. For example, each electrode sense channel may include the components needed to implement a measurement calibration methodology of the present invention, resulting in a duplication of such componentry for each electrode sense channel of the system. In configurations that use an integrational amplifier, integrator, ADC, DAC or PWM, demodulator, and other components, such as in the embodiment illustrated in FIG. 10, each electrode sense channel may include these components or, in other configurations, may share one or more of these components, such as by use of one or more multiplexers, for example.

FIG. 10 is a block diagram of circuitry 1000 configured for calibrating one or more parameters of a sensed response of each of a number of touch sensor electrodes in accordance with embodiments of the present invention. The circuitry 1000 shown in FIG. 10 includes a multiplexer (MUX) 1004 having inputs coupled to individual electrodes of a touch sensor (as shown in FIG. 9) via signal lines 1002. Although shown as a single multiplexer, it is understood that MUX 1004 may be representative of two or more multiplexers depending on the number electrode signal lines and other input/output lines that are implicated in a particular implementation. MUX 1004 has an output that is coupled to a buffer amplifier 1003. A power circuit 1001 is coupled to Vcc and Vee pins of MUX 1004 and to the output of buffer amplifier 1003 in the particular configuration shown in FIG. 10.

The output of buffer amplifier 1003 is coupled to measurement circuitry 1013. In the embodiment shown in FIG. 10, measurement circuitry 1013 loosely includes a pulse-width-modulator (PWM) type digital-to-analog converter (DAC) 1006, and a synchronous demodulator 1016. Outputs of measurement circuitry 1013 are coupled to differential inputs of a differential integrator 1012. An integrating capacitor 1011 and one or more switchable capacitors 1010 are coupled between the inverting input and output of integrator 1012. The output of integrator 1012 is coupled to an input of an ADC 1008, which may be incorporated in, or coupled to, a microprocessor 1005. Analog circuitry of measurement circuitry 1013, such as synchronous demodulator 1016, integrator 1012, and ADC 1008, provide for the measurement of sense channel signals. DAC 1018, PWM 1006, and switchable capacitors 1010 provide for sense channel response adjustment (e.g., offset adjustment), and firmware in microprocessor 1005 provides for sense channel calibration.

Control lines are coupled between microprocessor 1005 and measurement circuitry 1013 and MUX 1004, respectively. Microprocessor 1005 and filter and gain amplifier 1014 cooperate to generate a drive signal 1017 communicated to each of the electrodes of the touch sensor via signal lines 1002. An output signal 1015 of microprocessor 1005 is a digital signal representative of position calculated from signals that are calibrated in accordance with the principles of the present invention.

In general terms, an offset is adjusted by PWM 1006 which neutralizes a portion of the parasitic capacitances of each sense or external channel. Firmware adjusts the PWM 1006 preferably at power-up and/or other times when the touch screen is in a no-touch state, adjusting the width of the PWM 1006 until the ADC value of a no-touch condition is at the maximum of the ADC range. A touch, according to this implementation, drives the ADC count lower, preferably to a zero count indicative of the highest possible magnitude touch condition. The gain of each sense/external channel is adjusted by varying integrator duration (T) and/or integration capacitance by adjusting the state of switches 1010 to adjust the capacitance in the feedback path of integrator 1012. In conventional implementations, the gain response for the sense channels is specified as a global or common screen parameter, such that one adjustment is made for all electrodes on the X plane and one adjustment is made of all electrodes on the Y plane. A measurement calibration methodology of the present invention advantageously provides for gain (and other parameters) response adjustment on an individual, per-electrode sense channel basis.

Having described an embodiment of measurement circuitry as shown in FIG. 10, a description of how such circuitry can be implemented to compensate for variations in parasitic capacitance and impedance unique to the sense channels associated with each electrode of the touch sensor is now provided. It is understood that the following discussion is provided for illustrative non-limiting purposes only. For example, one or more components and/or functions of components described below may be optional, non-required features of the particular embodiment illustrated in FIG. 10.

As is shown in FIG. 10, filter and gain amplifier 1014 provides a drive signal 1017 that is communicated to each of the signal lines 1002 via resistors 1031. A drive signal may be developed from a signal produced by microprocessor 1005, such as a 3.3Vp/p signal. The drive signal may be variable so a signal of 5Vp/p may alternatively be applied to amplifier 1014. Filter and gain amplifier 1014 may be configured to include a 1-pole low pass filter having a gain of about 2, for example, in which case drive signal 1017 of about 6.6 V is developed at the output of filter and gain amplifier 1014. Filter and gain amplifier 1014 may have a DC offset, such that the DC average level at the output of filter and gain amplifier 1014 is about −1V at 6.6Vp/p or about OV at 10Vp/p.

The AC drive signal 1017 may be fed via source resistors 1031 to signal lines 1002 or, optionally, may be fed through a switch 1020. Switch 1020 allows for selection between multiple sources of user touches, such as user “A” and user “B” touch sources, for example. Drive signal 1017, preferably a 0VDC-referenced sine wave, is fed through resistors 1031 to the touch sensor electrodes via signal lines 1002 and to a non-inverting input of buffer amplifier 1003. Each of the resistors 1031 in parallel with resistor 1033 provides source resistance (corresponding to R_{S} 110 in FIG. 1). The resistance of resistor 1031 in parallel with the resistance of one of the resistors 1031 is preferably similar in magnitude to the capacitive impedance of the sensor electrodes to ground, such that a 6.6Vp/p signal from filter and gain amplifier 1014 will be attenuated to about 3Vp/p at the sensor electrodes. The frequency of drive signal 1017 may be changed to adjust this attenuation.

Multiplexer 1004, controllable by microprocessor 1005, selects 1 of N (e.g., N=24) sensor electrodes, from which sense channels signals may be measured and calibrated. To minimize the capacitance load on the selected sensor electrode, Vcc and Vee of the MUX 1004 may be driven with a signal equal to that applied to the selected sensor electrode via power circuit 1001.

Buffer amplifier 1003 buffers the selected signal provided at the output of MUX 1004 and feeds the selected signal to differential integrator 1012. Buffer amplifier 1003 also bootstraps all possible capacitances that connect to the signal path and to the sense electrode sourcing the selected signal by driving them with its output. These include the input of MUX 1004, shield plane on the controller printed circuit board, shield(s) on the touch sensor and cable, and the input capacitance of buffer amplifier 1003 (e.g., by driving the Vcc and Vee pins of the amplifiers). In one configuration, buffer amplifier 1003 has about 40 MHz GBWp, reduced slightly by resistive and stray capacitance loads, giving it an open loop gain of about 400 at 100 KHz. Appropriate resistors may be used to load buffer amplifier 1003 with resistance in parallel with load capacitance to help prevent oscillation.

The output of buffer amplifier 1003 is coupled to synchronous demodulator 1016, which may be configured as a double balanced synchronous demodulator, under the control of timing signals from microprocessor 1005. Outputs 1007 and 1009 feed phase-synchronous signal halves to respective differential inputs of differential integrator 1012. Output 1007 passes the negative half of the signal to the inverting input of differential integrator 1012 (via a resistor), and output 1009 passes the positive half of the signal to the non-inverting input of differential integrator 1012 (via a matching resistor). The integrating capacitor 1011 ramps from 0V to a level that must be less than the maximum conversion range of ADC 1008 (e.g., +3V). The integrating capacitor 1011 is preferably sized to allow for a full scale conversion range as set by microprocessor 1005 (e.g., 3V), which may be computed as (maximum difference input)*(integration interval).

The overall measurement gain is the integrator gain, set by integrating capacitor 1011 and input resistors. Gain may be adjusted by changing the integration capacitance or duration of integration. Additional capacitance may be added to the integrating capacitor 1011 by selectively closing one or more of switches 1010. This will add capacitance (one, two or more capacitors) in parallel to integrating capacitor 1011, thereby reducing gain proportionally.

The negative input signals fed to differential integrator 1012 via output 1007 are integrated and inverted by differential integrator 1012. The positive input signals fed to differential integrator 1012 via output 1009 generate a (1+integration) function. These are integrated, and the signal also appears (for ½ cycle) at the output during integration. This does not affect the final result, which is measured with the positive input of differential integrator 1012 at ground. The +3V maximum integration level is sufficiently far from the +5 Vcc supply voltage to differential integrator 1012 to allow for the positive signal excursions during integration.

Measurement control circuitry 1013 resets the differential integrator 1012, after which a current is fed into the differential integrator 1012 during integration. This current can be adjusted, via PWM 1006 timing under the control of microprocessor 1005, so that the output of differential integrator 1012 provides a signal of about +3V with no touch to the sensor, yielding substantially zero difference among the sensor electrodes once each is calibrated. PWM 1006 controls the switching of additional current via resistors not shown, which applies a positive current to the summing junction of differential integrator 1012. The integration current level is adjusted by PWM 1006 for each sense channel individually so that all channels integrate to the same level, such as a +3V level, even though the channels generally may have different levels of parasitic capacitance and impedances.

The following description is directed to a measurement methodology in accordance with an embodiment of the present invention. Measurement calibration is performed when the touch panel is in a quiescent state (i.e., absence of a touch). According to one configuration, the touch sensor electronics has one or more groups of touch measurement ports (TMPs) that are connected to arrays of electrodes with similar capacitance and resistance characteristics, including parasitic capacitance and touch capacitance ranges. A typical system implementation may include horizontal (H) electrodes in a digitizer array, which, if in a matrix, are used to measure Y position. The system may also include vertical (V) electrodes in a digitizer array, which, if in a matrix, are used to measure X position). An array of individual switches with similar capacitance characteristics may also be included.

In general, the measurement calibration procedure monitors one or more measurement parameters of each TMP in a group, and adjusts selected control parameters associated with each TMP in a group, so that the values of all measured parameters are equal (closely as possible), and measured values are also near a predefined value in the measurement range of the system, e.g., at one end of the ADC measurement range (either full scale or 0).

The measurement parameters of the calibration procedure may include magnitude of a signal (V_{I}) and signal phase (relative to V_{I}). Control parameters of the calibration procedure may include integration duration (essentially equal to gain) and integration time constant (such as by changing feedback capacitors, but may also be controlled by changing input resistors or by changing frequency or feedback gain of a sigma delta type integrator/ADC). Other control parameters include the operating frequency (typically 30 to 150 KHz), synchronous demodulator phase(s), signal (V_{I}) magnitude, and offset (generally a fixed adjustment to measured signal magnitude). Offset may be applied under microprocessor control, using a digital-to-analog converter (DAC), as is described herein. For example, a DAC may be a PWM output from the microprocessor that varies an amount of current or charge injected onto an integrator.

A given system may have preset limits. For example, an array of electrodes may be made of ITO having a certain electrode resistance and parasitic capacitance that limits the maximum operating frequency. A maximum integration duration may be set to optimize response time of the system.

Operating frequency may be pre-set manually, based on known parameters of the sensor to be used (e.g., parasitic capacitance, electrode resistance, overlay thickness). The operating frequency is set prior to the calibration procedure described below. Synchronous demodulator phase is also pre-set based on a manual interactive procedure. Both of these may be incorporated into the procedure below. Reference is made to the schematic shown in FIG. 10 for illustrative purposes. Annotation has been added to facilitate an enhanced understanding of this procedure.

Measurement Calibration Procedure—Example

AutoConfig for Each TMP Group:

Set integration capacitor 1011 at highest value, i.e., “most control” ramp (largest feedback capacitor=longest integration time constant).
Set integration duration for X and Y groups to optimal (may be selected as ˜4 mSec duration, chosen to yield [0.4 mSec x n=16 channels ˜6.4 mSec touch detection time).
   AutoConfig Loop

Auto PWM Loop
Let the slope rise faster until it almost clips (see, e.g., FIG. 6).
Start out with PWM 1006 set to “most control” ramp. (This adds negative offset, moving the integrator signal away from ADC+full scale).
If any ADC reading in the group at “most control” ramp clips, then PWM adjust fails (If applying maximum negative offset, and the integrator signal still reaches ADC+full scale, (+FS) some other parameter must be changed).
If an ADC reading is low, ease up on its PWM control. (Increase+offset incrementally until ADC readings are near+full scale. This is done independently for each channel of a group, so each channel may end up with a different offset).
If all ADC readings in the group are over the target and under the clip limit, then PWM adjust succeeds.
If any ADC reading in the group is under target at “least control” ramp, PWM adjust fails.
If the PWM width exceeds the integration duration, PWM adjust fails.

End Auto PWM Loop
If PWM adjust failed (i.e., clipped by exceeding the maximum ADC range), decrease the group integration duration.
If PWM adjust failed (i.e., clipped), but at a minimum allowed integration duration, AutoConfig fails.
If PWM adjust failed under target (not close enough to +Full scale), decrease integration capacitance (decrease integration time constant), or if integration capacitor 1011 is at lowest value, increase group integration duration.
If PWM adjust failed under target, but at a maximum allowed integration duration, AutoConfig fails.
If PWM adjust succeeds, AutoConfig succeeds.
   End AutoConfig Loop
   End AutoConfig

X and Y arrays of electrodes are processed at the same time (sequentially) but process through the AutoConfig procedure independently.

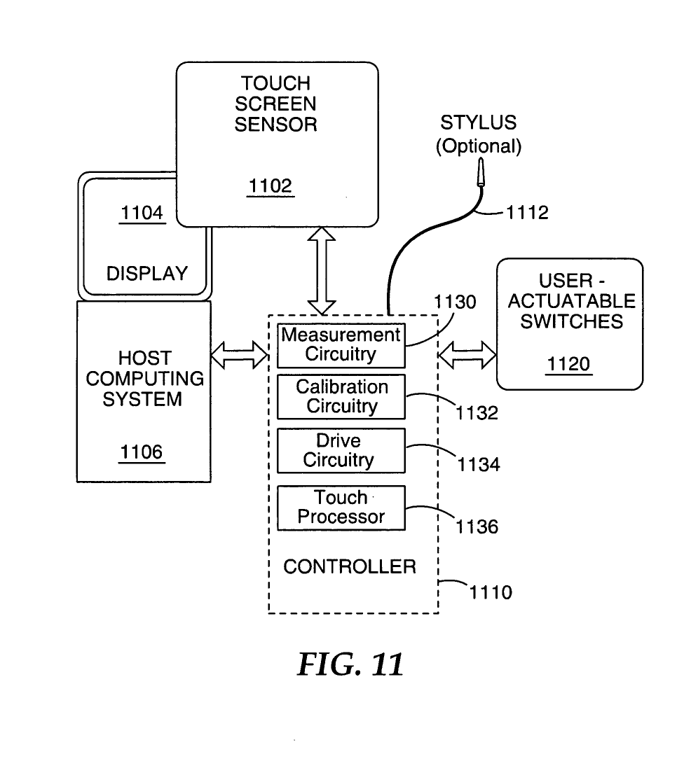

FIG. 11 illustrates a touch sensing system 1100 which incorporates a touch sensor that provides for gain and/or offset calibration on a per-sense channel basis in accordance with the principles of the present invention. The touch sensing system 1 100 shown in FIG. 11 includes a touch screen 1102 having one or more arrays of electrodes (e.g., matrix capacitive electrode arrays) which are connected to the touch measurement ports of a controller 1110. In a typical deployment configuration, the touch screen 1102 is used in combination with a display 1104 of a host computing system 1106 to provide for visual and tactile interaction between a user and the host computing system 1106.

It is understood that the touch screen 1102 can be implemented as a device separate from, but operative with, a display 1104 of the host computing system 1106. Alternatively, the touch screen 1102 can be implemented as part of a unitary system which includes a display device, such as a plasma, LCD, or other type of display technology suitable for incorporation of the touch screen 1102. It is further understood that utility is found in a system defined to include only the touch sensor 1102 and controller 1110 which, together, can implement a per-sense channel/external channel measurement calibration methodology of the present invention. It is also understood that utility is found in a system defined to include only the controller 1110 with which a per-sense channel/external channel measurement calibration methodology of the present invention may be implemented when the controller 1110 is coupled to a touch sensor of an appropriate configuration.

In the illustrative configuration shown in FIG. 11, communication between the touch screen 1102 and the host computing system 1106 is effected via the controller 1110. It is noted that one or more controllers 1110 can be connected to one or more touch screens 1102 and the host computing system 1106. The controller 1110 is typically configured to execute firmware/software that provides for detection of touches applied to the touch sensor 1102 by measuring calibrated signals on the electrodes of the touch screen 1102 in accordance with the principles of the present invention. It is understood that some of the functions and routines executed by the controller 1110 can alternatively be effected by additional digital or analog circuitry, for example adding or subtracting of signals or averaging of signals may be performed by analog circuits. It is understood that the functions and routines executed by the controller 1110 can alternatively be effected by a processor or controller of the host computing system 1106.

In one particular configuration, for example, the host computing system 1106 is configured to support an operating system and touch screen driver software. The host computing system 1106 can further support utility software and hardware. It will be appreciated that the various software/firmware and processing devices used to implement touch sensor processing and functionality can be physically or logically associated with the controller 1110, host computing system 1106, a remote processing system, or distributed amongst two or more of the controller 1110, host computing system 1106, and remote processing system.

The controller 1110 typically includes circuitry 1130 for measuring touch signals sensed using the electrodes and a touch processor 1136 configured to determine the location of the touch using the measured signals. Calibration circuitry 1132 is provided to independently adjust a sensed response of each electrode sense channel, and provide a calibrated touch signal to the measurement circuitry 1130. The touch sensing system 1100 may be used to determine the location of a touch by a finger, passive stylus or active stylus 1112. In applications that sense a finger touch or passive touch implement, the controller includes drive circuitry 1134 to apply an appropriate drive signal to the electrodes of the touch screen 1102. In some embodiments, circuitry 1130 for measuring the touch signals may be incorporated into the housing of the passive stylus. In systems using an active stylus 1112, the active stylus generates a signal that is transferred to the electrodes via capacitive coupling when the active stylus is near the surface of the touch sensor.

Some components of the controller 1110 may be mounted to a separate card that is removably installable within the host computing system chassis. Some components of the controller 1110, including drive circuitry 1134, calibration circuitry 1132, sensing or measurement circuitry 1130, including filters, sense amplifiers, A/D converters, and/or other signal processing circuitry, may be mounted in or on a cable connecting the touch screen 1102 to the controller 1110.

The foregoing description of the various embodiments of the invention has been presented for the purposes of illustration and description. It is not intended to be exhaustive or to limit the invention to the precise form disclosed. Many modifications and variations are possible in light of the above teaching. For example, embodiments of the present invention may be implemented in a wide variety of applications, including matrix capacitive touch sensors, single level array touch sensors, such as near-field imaging tough sensors, devices that include one or more arrays or arrangements of discrete switches, and devices that include a combination of a touch sensor and discrete switches. It is intended that the scope of the invention be limited not by this detailed description, but rather by the claims appended hereto.

What is claimed is:

1. A touch sensing system, comprising:
a touch surface; and
a touch sensor, comprising:
an array of electrodes configured to capacitively couple to a touch in proximity with the touch surface; and
circuitry coupled to each electrode via a channel and configured to sense signals present on the electrodes, the circuitry configured to independently adjust a sensed response of each electrode.

2. The system of claim 1, wherein the circuitry comprises a processor configured to implement an algorithm to adjust the sensed response of each electrode.

3. The system of claim 1, wherein the circuitry is configured to adjust the sensed response of each channel such that a parameter of sensed signals is substantially the same among individual channels.

4. The system of claim 1, wherein the circuitry is configured to adjust the sensed response of each channel by adjusting a gain of each channel.

5. The system of claim 1, wherein the circuitry is configured to adjust the sensed response of each channel by adjusting an offset of each channel.

6. The system of claim 5, wherein the circuitry is configured to adjust the offset to substantially null a parasitic capacitance associated with each channel.

7. The system of claim 1, wherein the circuitry is configured to adjust the sensed response of each channel by adjusting a gain and an offset of each channel.

8. The system of claim 1, wherein each channel comprises or is switchably coupled to an integrator.

9. The system of claim 8, wherein the integrator is coupled to digital-to-analog converter (DAC).

10. The system of claim 9, wherein the DAC is configured as a pulse width modulator.

11. The system of claim 1, wherein the circuitry is configured to integrate signals present on the electrodes.

12. The system of claim 1, wherein each channel comprises an integrator having an integration time constant, the circuitry configured to adjust a gain of each channel by adjusting the integration time constant of the integrator.

13. The system of claim 1, wherein each channel comprises an integrator having an integration time constant, the circuitry configured to adjust a gain of each channel by adjusting an integration time of the integrator.

14. The system of claim 1, wherein each channel comprises an integrator and a digital-to-analog converter (DAC), the DAC adjusting an offset of the integrator.

15. The system of claim 1, wherein each channel comprises an integrator, and the circuitry is configured to perform signal processing with the integrator and adjust an offset of the integrator.

16. The system of claim 1, wherein each channel comprises or is switchably coupled to an analog-to-digital converter (ADC).

17. The system of claim 1, wherein:
each channel comprises or is switchably coupled to an analog-to-digital converter (ADC); and
the circuitry is configured to adjust the sensed response of each channel to fall within a range of the ADC.

18. The system of claim 1, wherein:
each channel comprises or is switchably coupled to an analog-to-digital converter (ADC); and
the circuitry is configured to adjust the sensed response of each channel to correspond to a maximum range of the ADC in the absence of the touch in proximity with the touch surface.

19. The system of claim 1, wherein the circuitry is coupled to one or more user actuatable switches through individual input/output channels, the circuitry configured to independently adjust one or both of a gain and an offset of each input/output channel.

20. The system of claim 19, wherein the circuitry comprises an analog-to-digital converter (ADC) coupled to each of the channels and input/output channels, the circuitry configured to adjust one or both of the gain and offset of each input/output channel and one or both of a gain and an offset of each channel such that sensed signals communicated by the respective channels are within range of the ADC.

21. A method for use with a touch sensor comprising a touch surface, the method comprising:
measuring signals present on electrodes of an array of electrodes, the electrodes configured to capacitively couple to a touch in proximity with the touch surface; and
independently adjusting a sensed response of each electrode.

22. The method of claim 21, wherein adjusting the sensed response of each electrode comprises algorithmically adjusting the sensed response of each electrode.

23. The method of claim 21, wherein adjusting the sensed response of each electrode comprises adjusting a sensed response of a channel coupled to each electrode such that a parameter of sensed signals is substantially the same among individual channels.

24. The method of claim 21, wherein adjusting the sensed response of each electrode comprises adjusting a gain of individual channels coupled to respective electrodes.

25. The method of claim 21, wherein adjusting the sensed response of each electrode comprises adjusting an offset of individual channels coupled to respective electrodes.

26. The method of claim 21, wherein adjusting the sensed response of each electrode comprises substantially nulling a parasitic capacitance associated with individual channels coupled to respective electrodes.

27. The method of claim 21, wherein adjusting the sensed response of each electrode comprises adjusting a gain and an offset of individual channels coupled to respective electrodes.

28. The method of claim 21, wherein measuring the signals comprises integrating the signals.

29. The method of claim 21, wherein measuring the signals comprises integrating the signals, and adjusting the sensed response of each electrode comprises adjusting a time constant of integration to adjust a gain of individual channels coupled to respective electrodes.

30. The method of claim 21, wherein measuring the signals comprises integrating the signals, and adjusting the sensed response of each electrode comprises adjusting an integration time to adjust a gain of individual channels coupled to respective electrodes.

31. The method of claim 21, wherein measuring the signals comprises integrating the signals, and adjusting the sensed response of each electrode comprises performing signal processing with signal integration to adjust an offset of individual channels coupled to respective electrodes.

32. The method of claim 21, further comprising measuring signals received from input/output channels coupled to user actuatable switches, and independently adjusting one or both of a gain and an offset of each input/output channel.

33. A system comprising a touch sensor having a touch surface, the system comprising:
means for measuring signals present on electrodes of an array of electrodes, the electrodes configured to capacitively couple to a touch in proximity with the touch surface; and
means for independently adjusting a sensed response of each electrode.

34. The system of claim 33, comprising means for measuring signals received from input/output channels coupled to user actuatable switches, and means for independently adjusting one or both of a gain and an offset of each input/output channel.
